(19) United States
(12) Patent Application Publication
(10) Pub. No.: US 2015/0364964 A1
(43) Pub. Date: Dec. 17, 2015

(54) STARTER MOTOR

(71) Applicant: DENSO CORPORATION, Kariya-city (JP)

(72) Inventors: Takaki ONO, Tokai-shi (JP); Katsuhiko TABATA, Okazaki-shi (JP); Hiromasa YAMAMOTO, Chita-gun (JP)

(21) Appl. No.: 14/735,404

(22) Filed: Jun. 10, 2015

(30) Foreign Application Priority Data
Jun. 16, 2014 (JP) 2014-122987

(51) Int. Cl. H02K 5/10; F02N 11/00

(52) U.S. Cl. CPC H02K 5/10; F02N 11/00

(57) ABSTRACT

In a starter motor, a second hole is opened toward an outside at an upper side in a vertical direction of an outer opening of a first hole, and a filter having air permeability and water repellency is attached to the second hole. Accordingly, by not attaching the filter to the first hole, and by attaching the filter to the second hole, it is possible to suppress water from entering from the second hole without interfering with introduction of outside air, and without impairing a draining function of the first hole. Therefore, it is possible to enhance the waterproof structure of the starter motor without impairing the draining function.

### CROSS-REFERENCE TO RELATED APPLICATION

This application is based on and claims the benefit of priority from earlier Japanese Patent Application No. 2014-122987 filed Jun. 16, 2014, the description of which is incorporated herein by reference.

### TECHNICAL FIELD

The present disclosure relates to a starter motor that constitutes a starter for starting an engine.

### BACKGROUND

Conventionally, since the inside of a starter motor is kept airtight, when the starter is at a high temperature due to the heat of the engine, and when the starter is water-covered, a negative pressure is likely to be generated in the starter motor due to rapid cooling.

Therefore, since there is a possibility of sucking water from gaps between components due to the negative pressure, an elimination of the negative pressure is achieved by disposing a hole in an end frame of the starter motor to allow external air therein, for example.

Further, when the water enters into the starter motor and stays there, there is a possibility that rust is generated so that the brushes get stuck, and sliding failure of the brushes and a commutator may occur.

Thus, the hole is opened toward a lower side in a vertical direction in order to provide a draining function of the hole.

However, assuming a situation that a vehicle is flooded, since the hole is opened toward the lower side in the vertical direction, a possibility of water entering inside the starter motor from the hole increases.

Therefore, in order to increase the draining function of the starter motor, separately from the hole opened toward the lower side in the vertical direction (hereinafter referred to as a first hole), a second hole is disposed allowing introduction of outside air from the second hole to enhance the draining function of the first hole (refer to Japanese Patent Application Laid-Open Publication No. 2008-215095, for example).

That is, if the second hole is not disposed, and when the water enters inside the starter, the first hole is closed by water droplets, and there is a possibility that the water may not be drained, due to a pressure difference between the inside and outside of the starter or a water surface tension of the water droplets.

Therefore, in the structure of the Publication '095, by disposing the second hole and introducing outside air from the second hole, the draining function of the first hole is enhanced.

However, if the second hole is not provided, and when the negative pressure is generated inside the starter motor because the starter motor is cooled rapidly due to the flooding, a possibility of water being sucked from the first hole entering inside the starter motor is further increased.

Therefore, by disposing the second hole, the water is suppressed from being sucked from the first hole by eliminating the negative pressure due to the flooding.

In recent years, there is an increase in demanding further enhancement of the waterproof structure by increasing the resistance to covering by water, flooding, etc., in the starter, and further measures are required.

Here, as a measure to strengthen a waterproof structure of a rotary electric machine, a configuration that suppresses water from entering from a hole by attaching a filter having water repellency and air permeability to the hole has been considered (refer to Japanese Patent Application Laid-Open Publication No. 09-172750, for example).

Further, according to the waterproof structure of Publication '750, even if water enters the inside, it can be drained as water vapor.

However, although draining the water as the water vapor is possible when attaching the filter to the hole, it is difficult to drain water as a liquid, and the draining function is impaired.

Moreover, since the filter is mounted to all the holes in the Publication '750, if vaporization of water inside the rotary electric machine is insufficient, water is retained as a liquid, and a possibility of rust occurrence increases.

Therefore, the configuration of the Publication '750 is considered to be insufficient as a further enhancement of the waterproof structure.

### SUMMARY

An embodiment provides a starter motor that enhances a waterproof structure without impairing a draining function.

In a starter motor according to a first aspect, the starter motor includes an end frame that accommodates a brush and a commutator, and a first hole and a second hole that are disposed in the end frame to communicate between an inside and an outside of the end frame.

The first hole is open toward a lower side in a vertical direction and the second hole is opened toward an upper side in the vertical direction, and a filter having air permeability is attached to the second hole.

Accordingly, by not attaching the filter to the first hole, and by attaching the filter to the second hole, it is possible to suppress water from entering from the second hole without interfering with introduction of outside air and without impairing a draining function of the first hole.

Therefore, it is possible to enhance the waterproof structure of the starter motor without impairing the draining function.

### BRIEF DESCRIPTION OF THE DRAWINGS

In the accompanying drawings:

FIG. 1A shows a partial sectional view of a partial configuration of a starter motor (Embodiment);

FIG. 1B shows a partially enlarged view of a second hole in FIG. 1A (Embodiment);

FIG. 1C shows a partially enlarged view of a first hole in FIG. 1A (Embodiment);

FIG. 2A shows a partial sectional view of a partial configuration of a starter motor (Modification);

FIG. 2B shows a partially enlarged view of a second hole in FIG. 2A (Modification);

FIG. 2C shows a partially enlarged view of a first hole in FIG. 2A (Modification);

FIG. 3 shows a sectional view of a second hole (Modification); and

FIG. 4 is another sectional view of a second hole (Modification).

### DETAILED DESCRIPTION OF THE PREFERRED EMBODIMENTS

Hereinafter will be described an embodiment of a starter motor according to the present disclosure with reference to the accompanying drawings.

### Embodiment

### [Configuration of Embodiment]

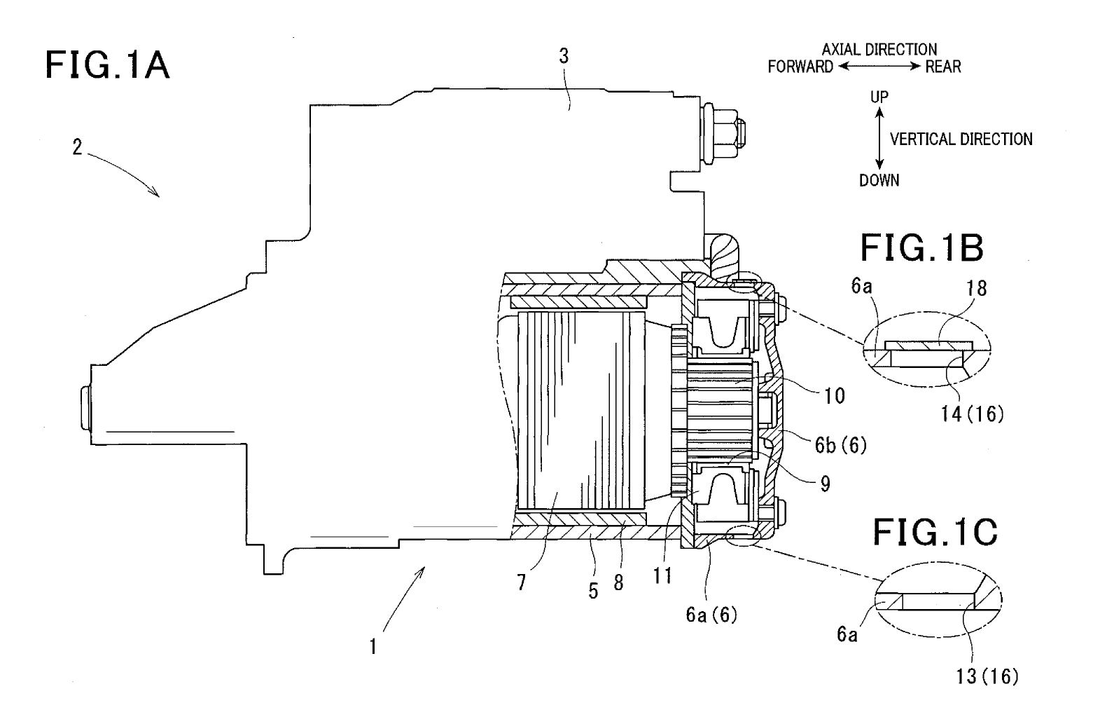

An overall structure of a starter motor 1 of an embodiment will be described with reference to FIGS. 1A, 1B and 1C.

The starter motor 1 is intended to constitute a starter 2 that starts an engine (not shown) mounted in an engine compartment of a vehicle (not shown).

In addition, the starter 2 performs a well-known operation to start the engine, i.e., the starter 2 pushes a pinion (not shown) axially forward by an electromagnetic switch 3 to engage the pinion with a ring gear (not shown), and rotates the ring gear through the pinion by a torque of the starter motor 1, for example.

Further, the starter motor 1, which is a DC motor that generates a torque by a well-known operation, accommodates an armature coil 7, permanent magnets 8, brushes 9, a commutator 10, brush holders 11 and the like in inner circumferences of a yoke 5 and an end frame 6.

Next, characteristic structures of the starter motor 1 will be described.

An outer wall in axially rear of the starter motor 1 is formed by the end frame 6 made of metal, and the brushes 9, the commutator 10, the brush holders 11 and the like are accommodated in the inner circumferences of the end frame 6.

First and second holes 13, 14 that open an inside of the end frame 6 to an outside are provided in the end frame 6, and it becomes possible to introduce outside air into the starter motor 1 by the first and second holes 13, 14.

In addition, the end frame 6 has a substantially cylindrical peripheral wall portion 6a having a rotation shaft of the starter motor 1 as a center axis, and a bottom wall portion 6b that forms a rear end of the starter motor 1 is disposed perpendicular with respect to the axial direction.

Both the first and second holes 13, 14 are through holes 16 penetrating the end frame 6.

The first hole 13 penetrates a portion disposed at a lower side in a vertical direction of the peripheral wall portion 6a, and opens toward the lower side in the vertical direction.

Therefore, the first hole 13 has a draining function of draining liquid water from the inside of the starter motor 1 to the outside.

Moreover, the second hole 14 penetrates a portion disposed at an upper side in a vertical direction of the peripheral wall portion 6a, and opens toward the upper side in the vertical direction.

In other words, the second hole 14 is opened toward the outside at the upper side in the vertical direction of an outer opening of the first hole 13.

Further, a filter 18 having air permeability and water repellency is attached to the second hole 14.

Therefore, the second hole 14 has a high resistance to covering by water, and the entry of water is suppressed.

The filter 18 is attached to an outer peripheral surface of the peripheral wall portion 6a by welding or bonding, and covers an outer opening of the second hole 14 from the outside.

### [Effect of Embodiment]

Accordingly, even when inside the starter motor 1 is at a high temperature due to the heat generated by the engine and a negative pressure is generated due to the covering by water of the starter motor 1, the negative pressure can be eliminated by introducing the outside air inside the starter motor 1 from both the first and second holes 13, 14.

Therefore, it is possible to prevent the water from being sucked from gaps between components by the negative pressure.

Further, even if the water enters inside the starter motor 1, it is possible that the liquid water can be drained via the first hole 13.

Furthermore, even when the first hole 13 is likely to be blocked by water droplets, water can be reliably drained from the first hole 13 by introducing the outside air from the second hole 14 so that the pressure difference between the inside and outside of the starter motor 1 can be eliminated as well as overcoming a surface tension occurring in the water droplets.

Moreover, even if the first hole 13 is blocked by the water due to the flooding or the like, the negative pressure is eliminated by introducing the outside air from the second hole 14 so that the water is suppressed from being sucked from the first hole 13.

In addition, by disposing the first and second holes 13, 14 in the end frame 6, it is possible to prevent the water from stagnating in vicinities of the brushes 9 and the commutator 10 that have large problems due to rust generation.

Further, the second hole 14 is opened toward the outside at the upper side in the vertical direction of the outer opening of the first hole 13, and the filter 18 having air permeability and water repellency is attached to the second hole 14.

Thus, without attaching the filter 18 to the first hole 13 and attaching the filter 18 to the second hole 14, it is possible to suppress the water from entering without hindering the introduction of outside air, and without impairing the draining function of the first hole 13 in the second hole 14.

Therefore, it is possible to enhance the waterproof structure without impairing the draining function in the starter motor 1.

Moreover, by opening the second hole 14 toward the outside at the upper side in the vertical direction of the outer opening of the first hole 13, it is possible to reduce the possibility of flooding up to the second hole 14 during flooding, while the filter 18 can be suppressed from deteriorating due to the covering by water.

It should be noted that the second hole 14 is such that a primary purpose is to assist introducing air into the inside of the starter motor 1.

Therefore, by increasing the effect of preventing entry of the water by attaching the filter 18 in the second hole 14, it is possible to increase a degree of freedom of a setting position of the second hole 14.

### [Modification]

It should be appreciated that, in the modification, components identical with or similar to those in the embodiment are given the same reference numerals, and structures and features thereof will not be described in order to avoid redundant explanation.

According to the starter motor 1 of the embodiment, although the second hole 14 is the through hole 16 penetrating the peripheral wall portion 6a of the end frame 6, aspects of the first and second holes 13, 14 are not limited to the embodiment.

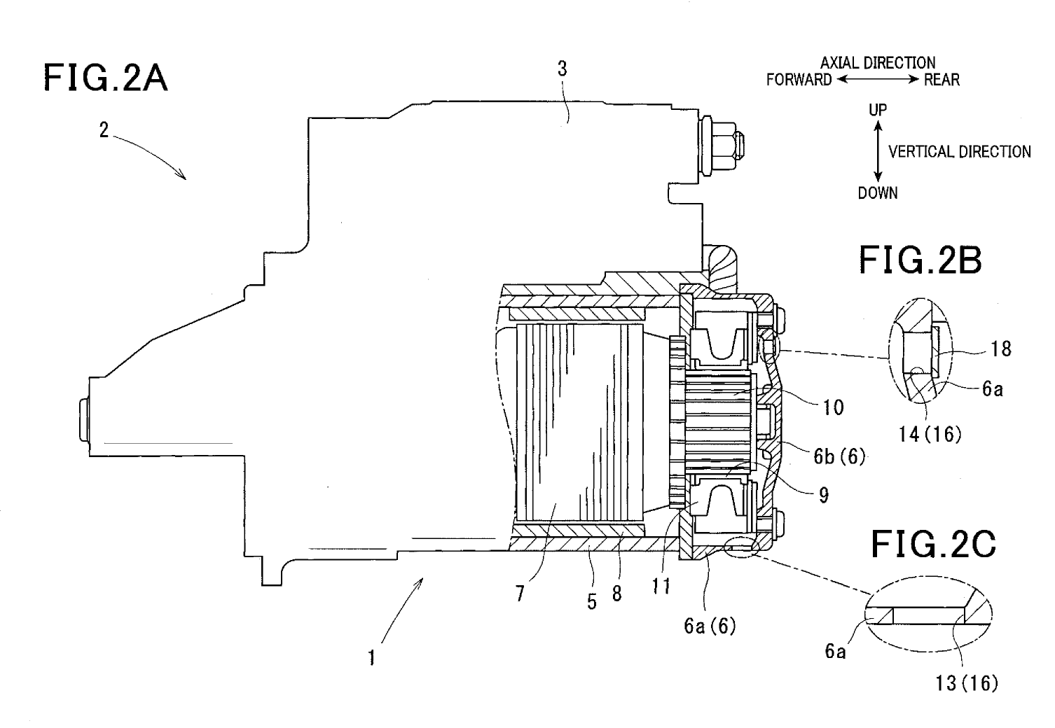

For example, as shown in FIGS. 2A, 2B and 2C, a through hole 16 penetrating in the axial direction may be disposed in the bottom wall 6b, and the through hole 16 disposed in the bottom wall 6b may be used as a second hole 14.

Further, according to the starter motor 1 of the embodiment, the first and second holes 13, 14 are the through holes 16 penetrating the end frame 6.

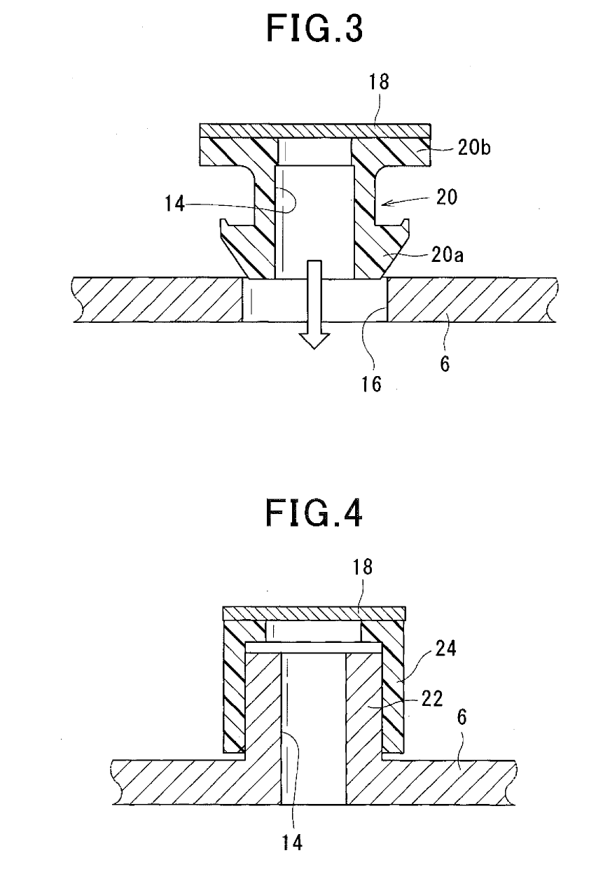

However, the through hole 16 may optionally not be used as the first or the second hole 13, 14 by itself, but inserting a pipe 20 into the through hole 16, as shown in FIG. 3, and an inner periphery of the pipe 20 may be utilized as the first or the second hole 13, 14.

That is, a hook 20a that hooks inside the end frame 6 is disposed to the pipe 20, and fixing the pipe 20 to the end frame 6 by hooking the hook 20a to the end frame 6, the inner periphery of the pipe 20 may be used as the first or the second hole 13, 14.

Further, when using the inner periphery of the pipe 20 as the second hole 14, a flange 20b is disposed at an opposite end to the hook 20a in the pipe 20, for example, and the filter 18 may be attached to the flange 20b.

Furthermore, as shown in FIG. 4, a cylindrical boss portion 22 projecting outward is formed in the end frame 6, and by opening an inner periphery of the boss portion 22 on the inside of the end frame 6, the inner periphery of the boss portion 22 may be used as the first or the second hole 13, 14.

Moreover, when using the inner periphery of the boss portion 22 as the second hole 14, it is possible in the following manner to attach the filter 18 to the end frame 6, for example.

That is, a cylindrical body 24 is provided separately from the end frame 6, and the filter 18 is attached so as to cover a one open end in the cylindrical body 24.

Then, by press-fitting the cylindrical body 24 attached with the filter 18 to the boss portion 22, it is possible to mount the filter 18 to the end frame 6.

In addition, although the second hole 14 is disposed in one position according to the starter motor 1 of the embodiment, the second hole 14 can be disposed at a plurality of positions.

Further, the starter motor 1 of the embodiment is a permanent magnet DC motor that includes the armature coil 7 and the permanent magnets 8.

However, a DC motor of a winding type that includes winding poles in place of the permanent magnets 8 may be employed as a starter motor 1.

What is claimed is:

1. A starter motor that constitutes a starter mounted on a vehicle comprising:
an end frame that accommodates a brush and a commutator; and
a first hole and a second hole that are disposed in the end frame to communicate between an inside and an outside of the end frame; wherein,
the first hole is open toward a lower side in a vertical direction and the second hole is opened toward an upper side in the vertical direction; and
a filter having air permeability is attached to the second hole.

2. The starter motor according to claim 1, wherein,
there is provided a through hole that penetrates the end frame; and
the filter is attached to the end frame.

3. The starter motor according to claim 1, wherein,
there is provided a pipe fixed to the end frame and a through hole that penetrates the end frame;
the pipe has a hook inserted inside the end frame from the through hole to be hooked to the end frame, and the pipe is fixed to the end frame by hooking the hook to the end frame; and
the filter is attached to the pipe.

4. The starter motor according to claim 1, wherein,
a cylindrical boss portion projecting outwardly is disposed in the end frame, and an inner periphery of the boss portion is opened to the inside of the end frame; and
the filter is attached to a cylindrical body provided separately from the end frame, and the cylindrical body is press-fitted to the boss portion.

5. The starter motor according to claim 1, wherein,
the second hole is disposed at a plurality of positions.

6. The starter motor according to claim 2, wherein,
the second hole is disposed at a plurality of positions.

7. The starter motor according to claim 3, wherein,
the second hole is disposed at a plurality of positions.

8. The starter motor according to claim 4, wherein,
the second hole is disposed at a plurality of positions.
